(19) United States
(12) Patent Application Publication
(10) Pub. No.: US 2018/0053055 A1
(43) Pub. Date: Feb. 22, 2018

(54) INTEGRATING AUGMENTED REALITY CONTENT AND THERMAL IMAGERY

(71) Applicant: DAQRI, LLC, Los Angeles, CA (US)

(72) Inventors: Samuel Finding, Santa Monica, CA (US); Lucas Kazansky, Los Angeles, CA (US); Naveen Anand Gunalan, Monterey Park, CA (US)

(21) Appl. No.: 15/243,730

(22) Filed: Aug. 22, 2016

(51) Int. Cl. G06K 9/00; G06K 9/62; G06T 19/00; G06T 15/04; H04N 5/33

(52) U.S. Cl. CPC G06K 9/00671; G06K 9/6202; H04N 5/33; G06T 15/04; G06T 19/006

(57) ABSTRACT

A wearable computing device provides augmented reality images of an environment in which the wearable computing device is worn. The wearable computing device is configured to detect one or more objects in the environment and acquire, by one or more cameras of the wearable computing device, one or more thermal images of at least one object of the detected one or more objects. The wearable computing device also obtains one or more instructions relating to the at least one object of the detected one or more objects based on the one or more acquired thermal images. The wearable computing device further generates augmented reality content having the obtained one or more instructions, and displays, by a display of the wearable computing device, the generated augmented reality content with one or more of the acquired thermal images of the at least one object of the detected one or more objects.

### TECHNICAL FIELD

The subject matter disclosed herein generally relates to integrating augmented reality content with thermal imagery and, in particular, to leveraging acquired thermal imagery to display augmented reality content relating to the objects associated with the acquired thermal imagery.

### BACKGROUND

Augmented reality (AR) is a live direct or indirect view of a physical, real-world environment whose elements are augmented (or supplemented) by computer-generated sensory input such as sound, video, graphics or Global Positioning System (GPS) data. With the help of advanced AR technology (e.g., adding computer vision and object recognition) the information about the surrounding real world of the user becomes interactive. Device-generated (e.g., artificial) information about the environment and its objects can be overlaid on the real world.

Typically, a user uses a computing device to view the augmented reality. Conventional computing devices often show a view of the user's environment as it appears to the user (e.g., within the light wavelengths perceivable by the human eye). However, in some circumstances, a user may need information about his or her environment that he or she cannot perceive (e.g., outside of the light wavelengths perceivable by the human eye). For example, where a surface does not change within the visible light spectrum according to temperature, the user may inadvertently come into contact with such surface and injure himself or herself. Thus, augmented reality within the visible light spectrum may be insufficient to ensure the safety of the user.

### BRIEF DESCRIPTION OF THE DRAWINGS

Some embodiments are illustrated by way of example and not limited to the figures of the accompanying drawings.

FIG. 1 is a block diagram illustrating an example of a network environment suitable for a wearable computing device, according to an example embodiment.

FIG. 2 is a block diagram of the wearable computing device of FIG. 1, according to an example embodiment

FIG. 3 is a block diagram illustrating different types of sensors used by the wearable computing device of FIG. 1, according to an example embodiment.

FIGS. 4A-4B illustrate an example of displaying selected thermal imagery with augmented reality content, according to an example embodiment.

FIG. 5 illustrates a further example of displaying thermal imagery with augmented reality content, according to an example embodiment.

FIGS. 6A-6B illustrate a method, according to an example embodiment, implemented by the wearable computing device of FIG. 1 for identifying objects and acquiring their corresponding thermal images.

FIG. 7 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

This disclosure provides for a wearable computing device that identifies objects using thermal imagery and displays augmented reality content in response to an analysis of the obtained thermal imagery. In one embodiment, the wearable computing device obtains thermal imagery for a recognized object. The obtained thermal imagery is then communicated to a server in communication with the wearable computing device. The server then performs a comparison of the obtained thermal imagery for the recognized object with baseline thermal imagery for the recognized object. Based on the comparison, the server communicates instructions and/or information to the wearable computing device to display as augmented reality content to the wearer. Such instructions and/or information may include whether the obtained thermal imagery indicates a problem with the recognized object or whether the recognized object is operating outside of normal operating parameters (e.g., according to the baseline thermal imagery).

Accordingly, in one embodiment, the disclosed wearable computing device includes a machine-readable memory storing computer-executable instructions and at least one hardware processor in communication with the machine-readable memory that, when the computer-executable instructions are executed, configures the wearable computing device to perform a plurality of operations. The plurality of operations includes detecting one or more objects in an environment in which the wearable computing device is being worn, and acquiring, by one or more cameras of the wearable computing device, one or more thermal images of at least one object of the detected one or more objects. The plurality of operations also includes obtaining one or more instructions relating to the at least one object of the detected one or more objects based on the one or more acquired thermal images, generating augmented reality content having the obtained one or more instructions, and displaying, by a display of the wearable computing device, the generated augmented reality content with one or more of the acquired thermal images of the at least one object of the detected one or more objects.

In another embodiment of the wearable computing device, the plurality of operations further comprises comparing one or more of the acquired one or more thermal images with one or more previously obtained thermal images of the at least one object of the detected one or more objects, and obtaining the one or more instructions comprises generating instructions based on the comparison.

In a further embodiment of the wearable computing device, the one or more previously obtained thermal images relate to an operating state of the at least one object of the detected one or more objects, and the instructions comprise a notification that the at least one object of the detected one or more objects is operating outside expected operating parameters.

In yet another embodiment of the wearable computing device, obtaining the one or more instructions comprise communicating the acquired one or more thermal images to a server in communication with the wearable computing device, and receiving the one or more instructions in response to the communication of the acquired one or more thermal images

In yet a further embodiment of the wearable computing device, the plurality of operations further comprises obtaining a three-dimensional model of the at least one object of the one or more detected objects, and displaying the acquired one or more thermal images as a texture applied to one or more surfaces of the three-dimensional model.

In another embodiment of the wearable computing device, the acquired one or more thermal images are associated with a first set of coordinates indicating a location of each of the acquired one or more thermal images, the at least one object is associated with a second set of coordinates indicating a location of the at least one object, and the plurality of operations further comprises determining a third set of coordinates for displaying the acquired one or more thermal images as the texture based on aligning the second set of coordinates with the first set of coordinates.

In a further embodiment of the wearable computing device, the plurality of operations further comprises identifying the at least one object of the detected one or more objects, and the one or more instructions are obtained in response to a comparison of the acquired one or more thermal images with a baseline thermal imaging profile associated with the identified at least one object.

This disclosure further describes a computer-implemented method for providing augmented reality images of an environment in which the wearable computing device is worn. In one embodiment, the computer-implemented method includes detecting, by a wearable computing device, one or more objects in an environment in which the wearable computing device is being worn, and acquiring, by one or more cameras of the wearable computing device, one or more thermal images of at least one object of the detected one or more objects. The computer-implemented method also includes obtaining one or more instructions relating to the at least one object of the detected one or more objects based on the one or more acquired thermal images, generating augmented reality content having the obtained one or more instructions, and displaying, by a display of the wearable computing device, the generated augmented reality content with one or more of the acquired thermal images of the at least one object of the detected one or more objects.

In another embodiment of the computer-implemented method, the method includes comparing one or more of the acquired one or more thermal images with one or more previously obtained thermal images of the at least one object of the detected one or more objects, and obtaining the one or more instructions comprises generating instructions based on the comparison.

In a further embodiment of the computer-implemented method, the one or more previously obtained thermal images relate to an operating state of the at least one object of the detected one or more objects, and the instructions comprise a notification that the at least one object of the detected one or more objects is operating outside expected operating parameters.

In yet another embodiment of the computer-implemented method, obtaining the one or more instructions comprises communicating the acquired one or more thermal images to a server in communication with the wearable computing device, and receiving the one or more instructions in response to the communication of the acquired one or more thermal images.

In yet a further embodiment of the computer-implemented method, the computer-implemented method includes obtaining a three-dimensional model of the at least one object of the one or more detected objects, and displaying the acquired one or more thermal images as a texture applied to one or more surfaces of the three-dimensional model.

In another embodiment of the computer-implemented method, the acquired one or more thermal images are associated with a first set of coordinates indicating a location of each of the acquired one or more thermal images, the at least one object is associated with a second set of coordinates indicating a location of the at least one object, and the computer-implemented method further comprises determining a third set of coordinates for displaying the acquired one or more thermal images as the texture based on aligning the second set of coordinates with the first set of coordinates.

In a further embodiment of the computer-implemented method, the computer-implemented method includes identifying the at least one object of the detected one or more objects, and the one or more instructions are obtained in response to a comparison of the acquired one or more thermal images with a baseline thermal imaging profile associated with the identified at least one object.

This disclosure also describes a machine-readable medium having computer-executable instructions stored thereon that, when executed by at least one hardware processor, cause a wearable computing device to perform a plurality of operations comprising detecting one or more objects in an environment in which the wearable computing device is being worn, acquiring, by one or more cameras of the wearable computing device, one or more thermal images of at least one object of the detected one or more objects, obtaining one or more instructions relating to the at least one object of the detected one or more objects based on the one or more acquired thermal images, generating augmented reality content having the obtained one or more instructions, and displaying, by a display of the wearable computing device, the generated augmented reality content with one or more of the acquired thermal images of the at least one object of the detected one or more objects.

In another embodiment of the machine-readable medium, the plurality of operations further comprises comparing one or more of the acquired one or more thermal images with one or more previously obtained thermal images of the at least one object of the detected one or more objects, and obtaining the one or more instructions comprises generating instructions based on the comparison.

In a further embodiment of the machine-readable medium, the one or more previously obtained thermal images relate to an operating state of the at least one object of the detected one or more objects, and the instructions comprise a notification that the at least one object of the detected one or more objects is operating outside expected operating parameters.

In yet another embodiment of the machine-readable medium, obtaining the one or more instructions comprises communicating the acquired one or more thermal images to a server in communication with the wearable computing device, and receiving the one or more instructions in response to the communication of the acquired one or more thermal images.

In yet a further embodiment of the machine-readable medium, the plurality of operations further comprises obtaining a three-dimensional model of the at least one object of the one or more detected objects, and displaying the acquired one or more thermal images as a texture applied to one or more surfaces of the three-dimensional model.

In another embodiment of the machine-readable medium, the acquired one or more thermal images are associated with a first set of coordinates indicating a location of each of the acquired one or more thermal images, the at least one object is associated with a second set of coordinates indicating a location of the at least one object, and the plurality of operations further comprises determining a third set of coordinates for displaying the acquired one or more thermal images as the texture based on aligning the second set of coordinates with the first set of coordinates.

Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

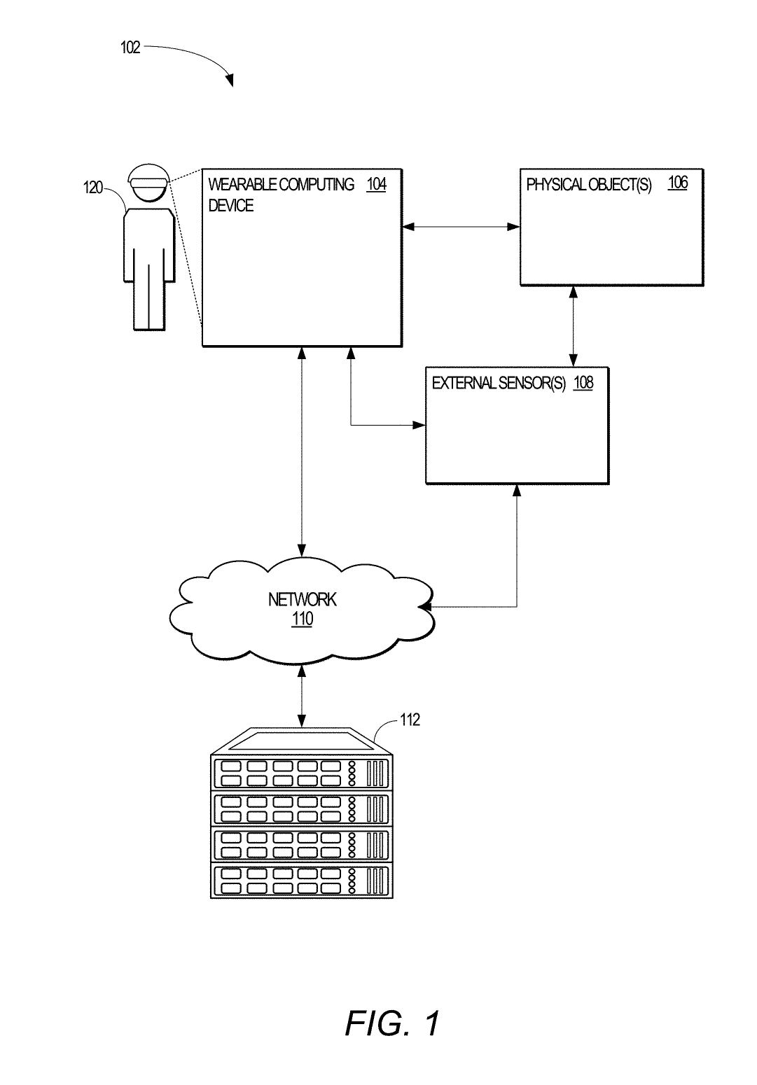

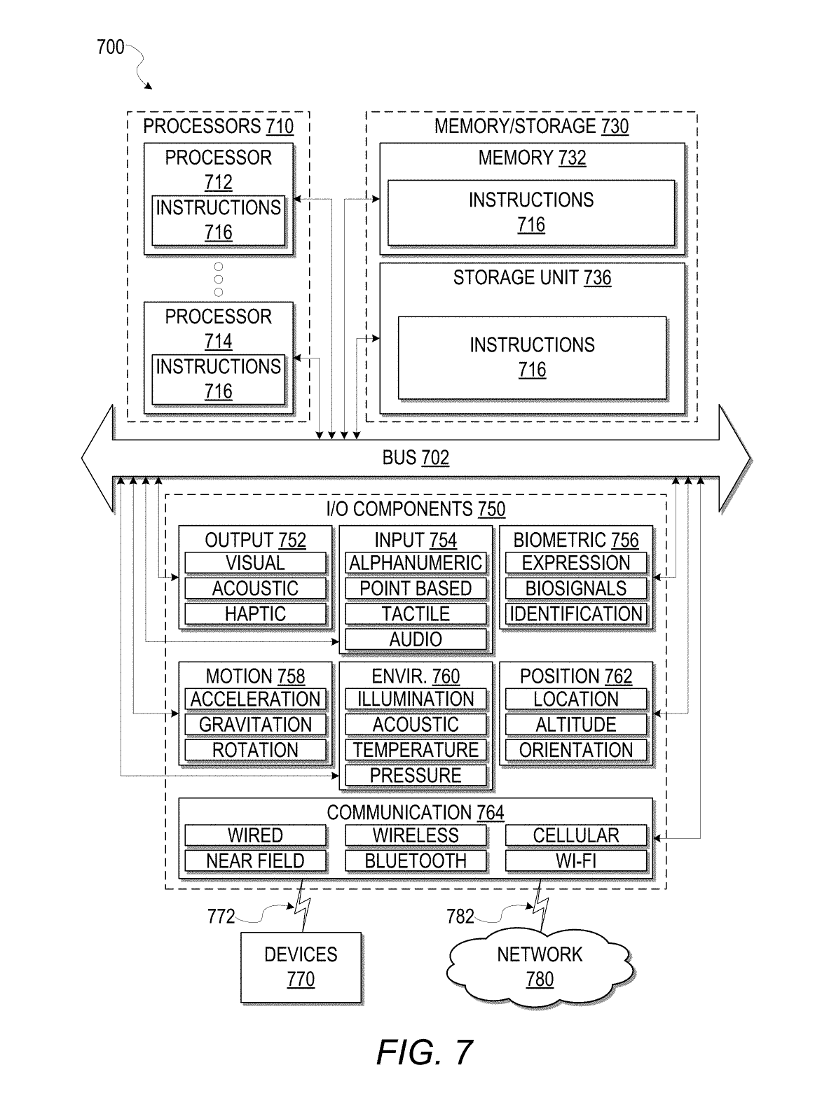

FIG. 1 is a block diagram illustrating an example of a network environment 102 suitable for a wearable computing device 104, according to an example embodiment. The network environment 102 includes the wearable computing device 104 and a server 112 communicatively coupled to each other via a network 110. The wearable computing device 104 and the server 112 may each be implemented in a computer system, in whole or in part, as described below with respect to FIG. 7.

The server 112 may be part of a network-based system. For example, the network-based system may be or include a cloud-based server system that provides additional information, such as three-dimensional (3D) models or other virtual objects, to the wearable computing device 104.

The wearable computing device 104 may be implemented in various form factors. In one embodiment, the wearable computing device 104 is implemented as a helmet, which the user 120 wears on his or her head, and views objects (e.g., physical object(s) 106) through a display device, such as one or more lenses, affixed to the wearable computing device 104. In another embodiment, the wearable computing device 104 is implemented as a lens frame, where the display device is implemented as one or more lenses affixed thereto. In yet another embodiment, the wearable computing device 104 is implemented as a watch (e.g., a housing mounted or affixed to a wrist band), and the display device is implemented as a display (e.g., liquid crystal display (LCD) or light emitting diode (LED) display) affixed to the wearable computing device 104.

A user 120 may wear the wearable computing device 104 and view one or more physical object(s) 106 in a real world physical environment. The user 120 may be a human user (e.g., a human being), a machine user (e.g., a computer configured by a software program to interact with the wearable computing device 104), or any suitable combination thereof (e.g., a human assisted by a machine or a machine supervised by a human). The user 120 is not part of the network environment 102, but is associated with the wearable computing device 104. For example, the wearable computing device 104 may be a computing device with a camera and a transparent display. In another example embodiment, the wearable computing device 104 may be hand-held or may be removably mounted to the head of the user 120. In one example, the display device may include a screen that displays what is captured with a camera of the wearable computing device 104. In another example, the display may be transparent or semi-transparent, such as lenses of wearable computing glasses or the visor or a face shield of a helmet.

The user 120 may be a user of an augmented reality (AR) application executable by the wearable computing device 104 and/or the server 112. The AR application may provide the user 120 with an AR experience triggered by one or more identified objects (e.g., physical object(s) 106) in the physical environment. For example, the physical object(s) 106 may include identifiable objects such as a two-dimensional (2D) physical object (e.g., a picture), a 3D physical object (e.g., a factory machine), a location (e.g., at the bottom floor of a factory), or any references (e.g., perceived corners of walls or furniture) in the real-world physical environment. The AR application may include computer vision recognition to determine various features within the physical environment such as corners, objects, lines, letters, and other such features or combination of features.

In one embodiment, the objects in an image captured by the wearable computing device 104 are tracked and locally recognized using a local context recognition dataset or any other previously stored dataset of the AR application. The local context recognition dataset may include a library of virtual objects associated with real-world physical objects or references. In one embodiment, the wearable computing device 104 identifies feature points in an image of the physical object 106. The wearable computing device 104 may also identify tracking data related to the physical object 106 (e.g., GPS location of the wearable computing device 104, orientation, or distance to the physical object(s) 106). If the captured image is not recognized locally by the wearable computing device 104, the wearable computing device 104 can download additional information (e.g., 3D model or other augmented data) corresponding to the captured image, from a database of the server 112 over the network 110.

In another example embodiment, the physical object(s) 106 in the image is tracked and recognized remotely by the server 112 using a remote context recognition dataset or any other previously stored dataset of an AR application in the server 112. The remote context recognition dataset may include a library of virtual objects or augmented information associated with real-world physical objects or references.

The network environment 102 also includes one or more external sensors 108 that interact with the wearable computing device 104 and/or the server 112. The external sensors 108 may be associated with, coupled to, or related to the physical object(s) 106 to measure a location, status, and characteristics of the physical object(s) 106. Examples of measured readings may include but are not limited to weight, pressure, temperature, velocity, direction, position, intrinsic and extrinsic properties, acceleration, and dimensions. For example, external sensors 108 may be disposed throughout a factory floor to measure movement, pressure, orientation, and temperature. The external sensor(s) 108 can also be used to measure a location, status, and characteristics of the wearable computing device 104 and the user 120. The server 112 can compute readings from data generated by the external sensor(s) 108. The server 112 can generate virtual indicators such as vectors or colors based on data from external sensor(s) 108. Virtual indicators are then overlaid on top of a live image or a view of the physical object(s) 106 (e.g., displayed on the display device 114) in a line of sight of the user 120 to show data related to the physical object(s) 106. For example, the virtual indicators may include arrows with shapes and colors that change based on real-time data. Additionally and/or alternatively, the virtual indicators are rendered at the server 112 and streamed to the wearable computing device 104.

The external sensor(s) 108 may include one or more sensors used to track various characteristics of the wearable computing device 104 including, but not limited to, the location, movement, and orientation of the wearable computing device 104 externally without having to rely on sensors internal to the wearable computing device 104. The external senor(s) 108 may include optical sensors (e.g., a depth-enabled 3D camera), wireless sensors (e.g., Bluetooth, Wi-Fi), Global Positioning System (GPS) sensors, and audio sensors to determine the location of the user 120 wearing the wearable computing device 104, distance of the user 120 to the external sensor(s) 108 (e.g., sensors placed in corners of a venue or a room), the orientation of the wearable computing device 104 to track what the user 120 is looking at (e.g., direction at which a designated portion of the wearable computing device 104 is pointed, e.g., the front portion of the wearable computing device 104 is pointed towards a player on a tennis court).

Furthermore, data from the external senor(s) 108 and internal sensors (not shown) in the wearable computing device 104 may be used for analytics data processing at the server 112 (or another server) for analysis on usage and how the user 120 is interacting with the physical object(s) 106 in the physical environment. Live data from other servers may also be used in the analytics data processing. For example, the analytics data may track at what locations (e.g., points or features) on the physical object(s) 106 or virtual object(s) (not shown) the user 120 has looked, how long the user 120 has looked at each location on the physical object(s) 106 or virtual object(s), how the user 120 wore the wearable computing device 104 when looking at the physical object(s) 106 or virtual object(s), which features of the virtual object(s) the user 120 interacted with (e.g., such as whether the user 120 engaged with the virtual object), and any suitable combination thereof. To enhance the interactivity with the physical object(s) 106 and/or virtual objects, the wearable computing device 104 receives a visualization content dataset related to the analytics data. The wearable computing device 104, via the display device 114, then generates a virtual object with additional or visualization features, or a new experience, based on the visualization content dataset.

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 7. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 110 may be any network that facilitates communication between or among machines (e.g., server 112), databases, and devices (e.g., the wearable computing device 104 and the external sensor(s) 108). Accordingly, the network 110 may be a wired network, a wireless network (e.g., a mobile or cellular network), or any suitable combination thereof. The network 110 may include one or more portions that constitute a private network, a public network (e.g., the Internet), or any suitable combination thereof.

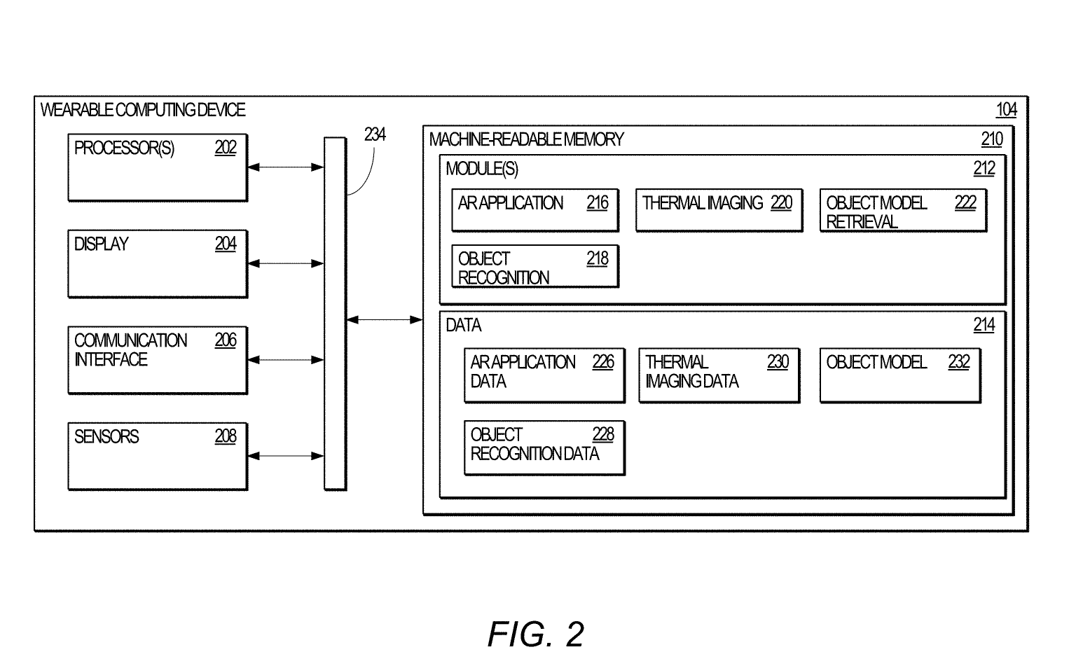

FIG. 2 is a block diagram of the wearable computing device 104 of FIG. 1, according to an example embodiment. The wearable computing device 104 includes various different types of hardware components. In one embodiment, the wearable computing device includes one or more processor(s) 202, a display 204, a communication interface 206, and one or more sensors 208. The wearable computing device 104 also includes a machine-readable memory 210. The various components 202-210 communicate via a communication bus 234.

The one or more processors 202 may be any type of commercially available processor, such as processors available from the Intel Corporation, Advanced Micro Devices, Qualcomm, Texas Instruments, or other such processors. Further still, the one or more processors 202 may include one or more special-purpose processors, such as a Field-Programmable Gate Array (FPGA) or an Application Specific Integrated Circuit (ASIC). The one or more processors 202 may also include programmable logic or circuitry that is temporarily configured by software to perform certain operations. Thus, once configured by such software, the one or more processors 202 become specific machines (or specific components of a machine) uniquely tailored to perform the configured functions and are no longer general-purpose processors.

The display 204 may include a display surface or lens configured to display AR content (e.g., images, video) generated by the one or more processor(s) 202. In one embodiment, the display 204 is made of a transparent material (e.g., glass, plastic, acrylic, etc.) so that the user 120 can see through the display 204. In another embodiment, the display 204 is made of several layers of a transparent material, which creates a diffraction grating within the display 204 such that images displayed on the display 204 appear holographic. The processor(s) 202 are configured to display a user interface on the display 204 so that the user 120 can interact with the wearable computing device 104.

The communication interface 206 is configured to facilitate communications between the wearable computing device 104, the user 120, the external sensor(s) 108, and the server 112. The communication interface 206 may include one or more wired communication interfaces (e.g., Universal Serial Bus (USB), an I²C bus, an RS-232 interface, an RS-485 interface, etc.), one or more wireless transceivers, such as a Bluetooth® transceiver, a Near Field Communication (NFC) transceiver, an 802.11x transceiver, a 3G (e.g., a GSM and/or CDMA) transceiver, a 4G (e.g., LTE and/or Mobile WiMAX) transceiver, or combinations of wired and wireless interfaces and transceivers. In one embodiment, the communication interface 206 interacts with the sensors 208 to provide input to the wearable computing device 104. In this embodiment, the user 120 may engage in gestures, eye movements, speech, or other physical activities that the wearable computing device 104 interprets as input (e.g., via the AR application 214 and/or input detection module 218).

To detect the movements of the user 120, the wearable computing device 104, and/or other objects in the environment, the wearable computing device 104 includes one or more sensors 208. The sensors 208 may generate internal tracking data of the wearable computing device 104 to determine a position and/or an orientation of the wearable computing device 104. In addition, the sensors 208 cooperatively operate so as to assist the wearable computing device 104 in identifying objects and obtaining thermal imagery for objects within the environment where the wearable computing device 104 is located.

The position and the orientation of the wearable computing device 104 may be used to identify real-world objects in a field of view of the wearable computing device 104. For example, a virtual object may be rendered and displayed in the display 204 when the sensors 208 indicate that the wearable computing device 104 is oriented towards a real-world object (e.g., when the user 120 looks at one or more physical object(s) 106) or in a particular direction (e.g., when the user 120 tilts his head to watch his wrist).

The wearable computing device 104 may display a virtual object in response to a determined geographic location of the wearable computing device 104. For example, a set of virtual objects may be accessible when the user 120 of the wearable computing device 104 is located in a particular building. In another example, virtual objects, including sensitive material, may be accessible when the user 120 of the wearable computing device 104 is located within a predefined area associated with the sensitive material and the user 120 is authenticated. Different levels of content of the virtual objects may be accessible based on a credential level of the user 120. For example, a user who is an executive of a company may have access to more information or content in the virtual objects than a manager at the same company. The sensors 208 may be used to authenticate the user 120 prior to providing the user 120 with access to the sensitive material (e.g., information displayed in as a virtual object such as a virtual dialog box in a transparent display). Authentication may be achieved via a variety of methods such as providing a password or an authentication token, or using sensors 208 to determine biometric data unique to the user 120.

The wearable computing device 104 is further configured to display thermal imagery corresponding to objects detected by the wearable computing device 104. In one embodiment, the wearable computing device 104 detects objects within its environment and retrieves a three-dimensional model corresponding to the detected object. The wearable computing device 104 also obtains thermal imagery corresponding to the detected object. The wearable computing device 104 then maps the obtained thermal imagery as a texture to the three-dimensional model of the detected object. The wearable computing device 104 then displays the thermal imagery on the display 204. In this manner, the wearable computing device 104 displays the thermal imagery as augmented reality content, which helps the user to visualize the thermal output of the object being viewed through the wearable computing device 104.

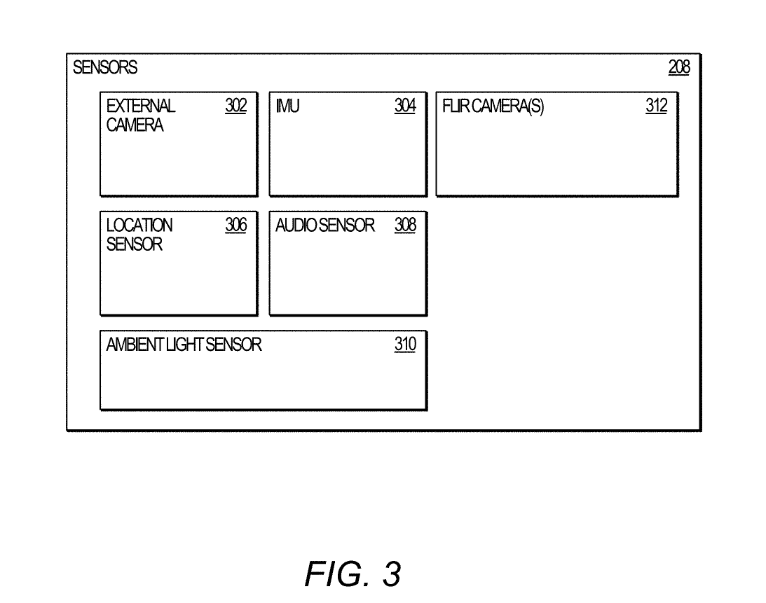

FIG. 3 is a block diagram illustrating different types of sensors 208 used by the wearable computing device 104 of FIG. 1, according to an example embodiment. For example, the sensors 208 may include an external camera 302, an inertial measurement unit (IMU) 304, a location sensor 306, an audio sensor 308, an ambient light sensor 310, and one or more forward looking infrared (FLIR) camera(s) 312. One of ordinary skill in the art will appreciate that the sensors illustrated in FIG. 3 are examples, and that different types and/or combinations of sensors may be employed in the wearable computing device 104.

The external camera 302 includes an optical sensor(s) (e.g., camera) configured to capture images across various spectrums. For example, the external camera 302 may include an infrared camera or a full-spectrum camera. The external camera 302 may include a rear-facing camera(s) and a front-facing camera(s) disposed in the wearable computing device 104. The front-facing camera(s) may be used to capture a front field of view of the wearable computing device 104 while the rear-facing camera(s) may be used to capture a rear field of view of the wearable computing device 104. The pictures captured with the front- and rear-facing cameras may be combined to recreate a 360-degree view of the physical environment around the wearable computing device 104.

The IMU 304 may include a gyroscope and an inertial motion sensor to determine an orientation and/or movement of the wearable computing device 104. For example, the IMU 304 may measure the velocity, orientation, and gravitational forces on the wearable computing device 104. The IMU 304 may also measure acceleration using an accelerometer and changes in angular rotation using a gyroscope.

The location sensor 306 may determine a geolocation of the wearable computing device 104 using a variety of techniques such as near field communication (NFC), the Global Positioning System (GPS), Bluetooth®, Wi-Fi®, and other such wireless technologies or combination of wireless technologies. For example, the location sensor 306 may generate geographic coordinates and/or an elevation of the wearable computing device 104.

The audio sensor 308 may include one or more sensors configured to detect sound, such as a dynamic microphone, condenser microphone, ribbon microphone, carbon microphone, and other such sound sensors or combinations thereof. For example, the microphone may be used to record a voice command from the user (e.g., user 120) of the wearable computing device 104. In other examples, the microphone may be used to measure an ambient noise (e.g., measure intensity of the background noise, identify specific type of noises such as explosions or gunshot noises).

The ambient light sensor 310 is configured to determine an ambient light intensity around the wearable computing device 104. For example, the ambient light sensor 314 measures the ambient light in a room in which the wearable computing device 104 is located. Examples of the ambient light sensor 310 include, but are not limited to, the ambient light sensors available from ams AG, located in Oberpremstatten, Austria.

The one or more FLIR camera(s) 312 are configured to capture and/or obtain thermal imagery of objects being viewed by the wearable computing device 104 (e.g., by the external camera 302). One of ordinary skill in the art will appreciate that the FLIR camera(s) 312 illustrated in FIG. 3 and described below are examples, and that different types and/or combinations of infrared imaging devices may be employed in the wearable computing device 104.

The FLIR camera(s) 312 may be affixed to different parts and/or surfaces of the wearable computing device 104 depending upon its implementation. For example, where the wearable computing device 104 is implemented as a head-mounted device, one or more of the FLIR camera(s) 312 may be affixed or mounted in a forward-looking or rearward-looking position on an exterior or interior surface of the wearable computing device 104. As another example, where the wearable computing device 104 is implemented as a wrist-mounted device (e.g., a watch), one or more of the FLIR camera(s) 312 may be affixed or disposed on a surface perpendicular to a surface having the display 204. In either examples, the one or more FLIR camera(s) 312 are arranged or disposed within the wearable computing device 104 such that the FLIR camera(s) 312 obtain thermal imagery within the environment of the wearable computing device 104.

In one embodiment, the FLIR camera(s) 312 are configured to capture thermal imagery of objects detected by the wearable computing device 104 and/or designated by the user 120. In this embodiment, the FLIR camera(s) 312 may operate so as to capture the thermal energy being emitted by the designated object(s). In another embodiment, the FLIR camera(s) 312 are configured to capture thermal imagery without the explicit designation of object(s) by the user, in which case, the wearable computing device 104 and/or the server 112 then selectably modifies to correspond to object(s) detected by the wearable computing device 104 and/or the server 112. Further still, the wearable computing device 104 and/or the server 112 may leverage the obtained thermal imagery to detect and/or identify object(s). As discussed below with reference to FIG. 2, the obtained thermal imagery may then be projected on the display 204 to be viewed by the user 120.

Referring back to FIG. 2, the machine-readable memory 210 includes various modules 212 and data 214 for implementing the features of the wearable computing device 104. The machine-readable memory 210 includes one or more devices configured to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable memory” should be taken to include a single medium or multiple media (e.g., a centralized or distributed database, or associated caches and servers) able to store the modules 212 and the data 214. Accordingly, the machine-readable memory 210 may be implemented as a single storage apparatus or device, or, alternatively and/or additionally, as “cloud-based” storage systems or storage networks that include multiple storage apparatus or devices. As shown in FIG. 2, the machine-readable memory 210 excludes signals per se.

In one embodiment, the modules 212 are written in a computer-programming and/or scripting language. Examples of such languages include, but are not limited to, C, C++, C#, Java, JavaScript, Perl, Python, Ruby, or any other computer programming and/or scripting language now known or later developed.

The modules 212 include one or more modules 216-224 that implement the features of the wearable computing device 104. In one embodiment, the modules 212 include an AR application 216, an object recognition module 218, a thermal imaging module 220, and an object model retrieval module 222. The data 214 includes one or more different sets of data 226-232 used by, or in support of, the modules 212. In one embodiment, the data 214 includes AR application data 226, object recognition data 228, thermal imaging data 230, and object model data 232, and thermal occlusion data 234.

The AR application 216 is configured to provide the user 120 with an AR experience triggered by one or more of the physical object(s) 106 in the user's 120 environment. Accordingly, the machine-readable memory 210 also stores AR application data 222 which provides the resources (e.g., sounds, images, text, and other such audiovisual content) used by the AR application 216. In response to detecting and/or identifying physical object(s) 106 in the user's 120 environment, the AR application 216 generates audiovisual content (e.g., represented by the AR application data 222) that is displayed on the display 204. To detect and/or identify the physical object(s) 106, the AR application 216 may employ various object recognition algorithms and/or image recognition algorithms.

The AR application 216 may further generate and/or display interactive audiovisual content on the display 204. In one embodiment, the AR application 214 generates an interactive graphical user interface that the user 120 may use to interact with the AR application 216 and/or control various functions of the wearable computing device 104. In addition, the wearable computing device 104 may translate physical movements and/or gestures, performed by the user 120, as input for the graphical user interface.

The object recognition module 218 is configured to identify and/or detect objects within the environment of the wearable computing device 104. In one embodiment, the object recognition module 218 communicates with one or more of the sensors 208 to identify the objects within the environment. For example, and with reference to FIG. 3, the external camera 302 may communicate one or more images to the object recognition module 218, which then performs one or more object recognition algorithms on the received images. The objects identified and/or detected by the object recognition module 218 are then stored as the object recognition data 228. The object recognition module 218 may perform object recognition on the images for previously unidentified objects and may also perform the object recognition on the images according to predefined fiducial markers. With previously unidentified objects, the object recognition module 218 may reference a database of objects and/or a classifier (e.g., via the server 112) to classify the unidentified objects and, with fiducial markers, may reference a database of fiducial markers to identify the object to which the fiducial marker is affixed.

In an alternative embodiment, the object recognition module 218 communicates the images obtained by the sensors 208 to the server 112, which performs the object recognition and/or detection algorithms on the received images. The server 112 communicates the detected objects to the object recognition module 218 via the communication interface 206, which then stores the detected objects as the object recognition data 228.

The object recognition data 228 may store a variety of information about a given object. In one embodiment, such information may include the type of object, whether the object is assigned a formal or informal name, the location of the object relative to the Earth (e.g., via latitude, longitude, and elevation coordinates), the location of the object relative to the wearable computing device 104 (e.g., distance, elevation, etc.), a three-dimensional model associated with the object (e.g., a three-dimensional graphical object that can be displayed via the AR application 216), and a thermal imaging profile associated with the detected object. In one embodiment, the thermal imaging profile includes various thermal images (or representations of such thermal images) that represent the object operating a different states (where applicable). For example, where the detected objects include one or more water pipes, the thermal imaging profile may include thermal images associated with the water pipes that indicate the various temperatures emitted by the water pipes depending on the temperature of the water being carried. As another example, where the detected objects include one or more steam pipes, the thermal imaging profile may include thermal images that indicate the temperatures emitted by the steam pipes at various stages of their operation (e.g., off, warming up, steam-filled, etc.). As discussed below, this thermal imaging profile can be used by the server 112 and/or the wearable computing device 104 to inform the user 120 whether there is a potential problem with the object being viewed by the wearable computing device 104 that would otherwise be difficult to see with the naked eye.

The thermal imaging module 220 is configured to acquire one or more thermal images of the environment and/or selected objects being viewed by the wearable computing device 104. In one embodiment, the thermal imaging module 220 communicates with one or more sensors 208 (e.g., the FLIR camera(s) 312) to acquire the one or more thermal images. The thermal images acquired by the thermal imaging module 220 are then stored as the thermal imaging data 230. In one embodiment, the thermal imaging module 220 acquires the thermal imaging data 230 at a framerate equal to, or higher than, the framerate perceivable by the human eye (e.g., 30 frames per second, 23.97 frames per second, 29.97 frames per second, etc.). In this embodiment, the thermal imaging data 230 may be displayed by the AR application 216, which appears as a video of thermal imagery to the user 120.

In addition, the thermal imaging data 230 may be mapped to the objects detected by the object recognition module 218 and stored as the object recognition data 228. As discussed previously, an object recognized by the wearable computer device 104 (e.g., via the object recognition module 218) may be associated with a three-dimensional model. In one embodiment, an object model retrieval module 222 is configured to retrieve the three-dimensional model, e.g., from the server 112 via the communicate interface 206. The object model retrieval module 222 may then store the retrieved three-dimensional model as the object model 232. By having a three-dimensional model (e.g., the object model 232) of a recognized object, the AR application 216 can apply the thermal imaging data 230 as a texture to one or more surfaces of the object model 232. Using the various sensors 208 of the wearable computing device 104, the AR application 216 may apply various graphical transformations to the thermal imaging data 230 (e.g., scaling, skewing, rotations, etc.) to align with one or more surfaces of the object model 232. In this manner, the AR application 216 can display the thermal imaging data 230 as augmented reality content via the display 204, with or without the associated object model 232. Thus, when the user 120 is viewing the object within view of the wearable computing device 104, the user 120 can perceive the thermal energy being emitted by the object as if the thermal energy was perceptible within the light wavelengths detectable by the human eye.

In some instances, the thermal imaging data 230 is not mapped to a particular object model (e.g., object model 232), but is displayed along with other augmented reality content on the display 204. In this regard, the AR application 216 is configured to display thermal images (e.g., the thermal imaging data 230) as it is acquired by the one or more sensors 208 without performing the texture mapping operation. In this regard, the user 120 of the wearable computing device 104 views the thermal imaging data 230 as it would appear to the sensors 208 rather than being graphically transformed to map to a particular object model 232.

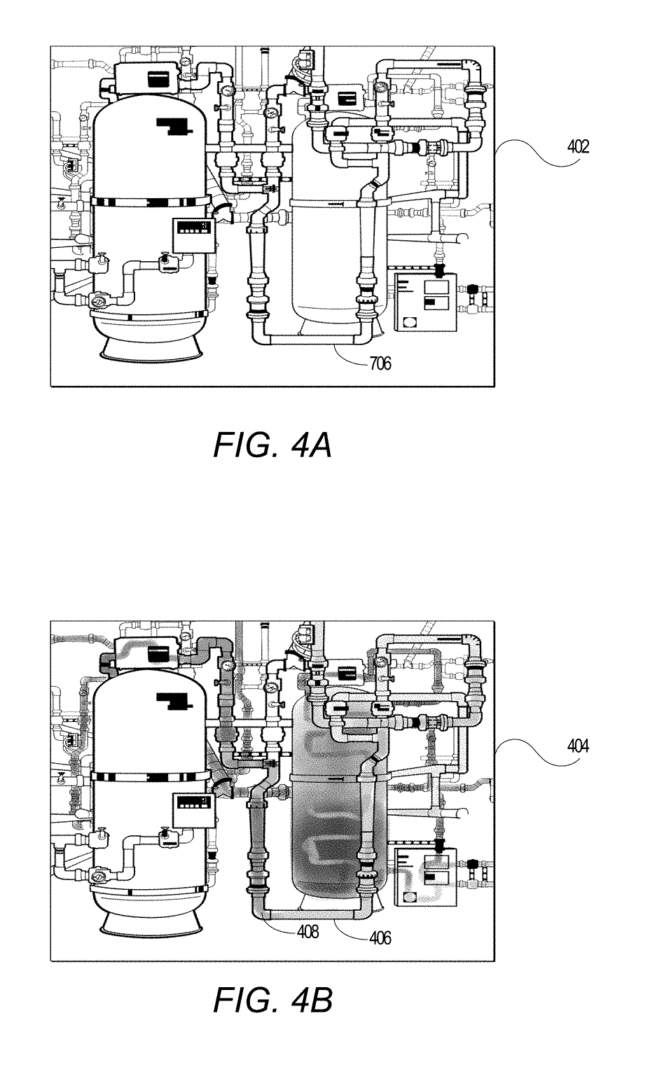

FIGS. 4A-4B illustrate an example of displaying thermal imagery with augmented reality content, according to an example embodiment. In FIG. 4A, a scene 402 includes one or more objects 406 that the object recognition module 218 identifies and/or detects. In particular, the one or more objects 406 include various pipes and boilers for a heating system. In one embodiment, the object recognition module 218 may retrieve a three-dimensional model corresponding to the detected one or more objects 406 via the communication interface 206, which the object recognition module 218 stores as the object model 232. Additionally and/or alternatively, the object recognition module 218 may execute one or more object recognition algorithms to identify, detect, and/or distinguish the various one or more objects 406 present in the scene 402.

In FIG. 4B, the wearable computing device 104 invokes the thermal imaging module 220 to obtain thermal imagery 408 of the one or more detected objects 406. As explained above, the AR application 216 may map the obtained thermal imagery 408 to the detected one or more objects 406. Thus, when the user 120 requests that the AR application 216 display the obtained thermal imagery 408, the AR application 216 displays the obtained thermal imagery 408 as augmented reality content. In one embodiment, the wearable computing device 104 displays thermal imagery 408 for the one or more detected objects 406 that are within view of the user 120. Thus, in this embodiment, the thermal imagery for objects that are in view of the user 120 may not be displayed. This approach ensures that the user 120 is shown thermal imagery for objects that are within view, while not displaying the thermal imagery for objects that are not within view. In an alternative embodiment, the wearable computing device 104 displays thermal imagery for one or more objects regardless of whether such objects are within view of the user 120.

Additionally, and/or alternatively, the obtained thermal imagery 408 may be textured map to a three-dimensional model of the one or more objects 406 (e.g., the object model 232) such that the user 120 can view the thermal imagery 408 from different angles as he or she moves about the environment where the wearable computing device 104 is located.

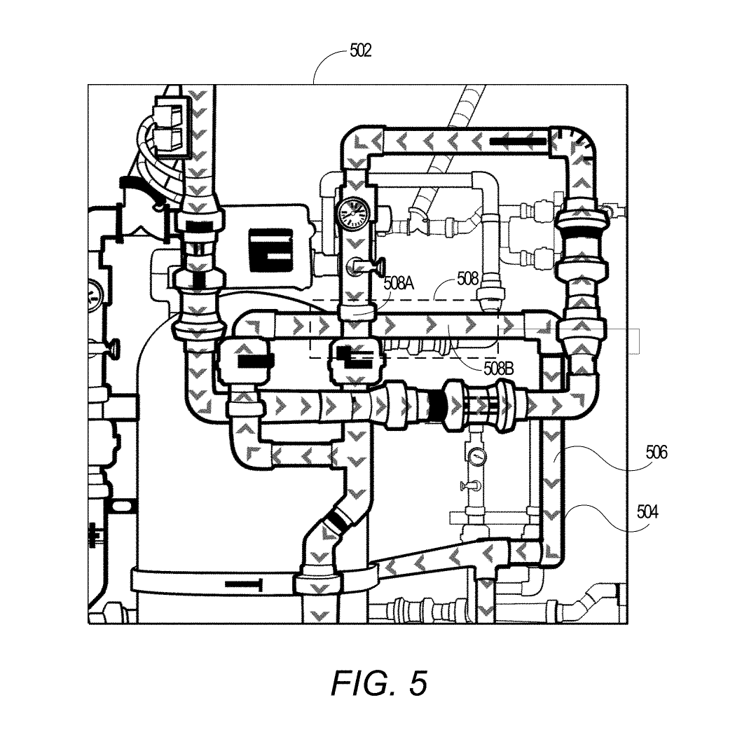

FIG. 5 illustrates a further example of displaying thermal imagery with augmented reality content, according to an example embodiment. In FIG. 5, the user 120 views a scene 502 via the display 204 that includes augmented reality content 506 derived from one or more thermal images obtained by the thermal imaging module 220 and mapped to the one or more objects 504 identified and/or detected by the object recognition module 218. The augmented reality content 506 includes the direction of flow for fluid within the pipes (e.g., the one or more objects 504) identified and/or detected by the object recognition module 218. In one embodiment, the flow direction is determined by performing a gradient differential analysis on the obtained thermal imagery, which indicates in which direction the warmer (or hotter) fluid is traveling.

In addition, as shown within the boxed portion 508, augmented reality content 508A associated with a first pipe appears overlaid augmented reality content 508B associated with a second pipe. In this manner, the wearable computing device 104 provides a real-time, or near real-time, view of thermal imagery for objects within view as those objects spatially relate to one another and the wearable computing device 104. This functionality allows the user 120 to readily discern and identify particular elements of thermal imagery (e.g., a specific pipe) from a set of thermal imagery that appears nominally similar

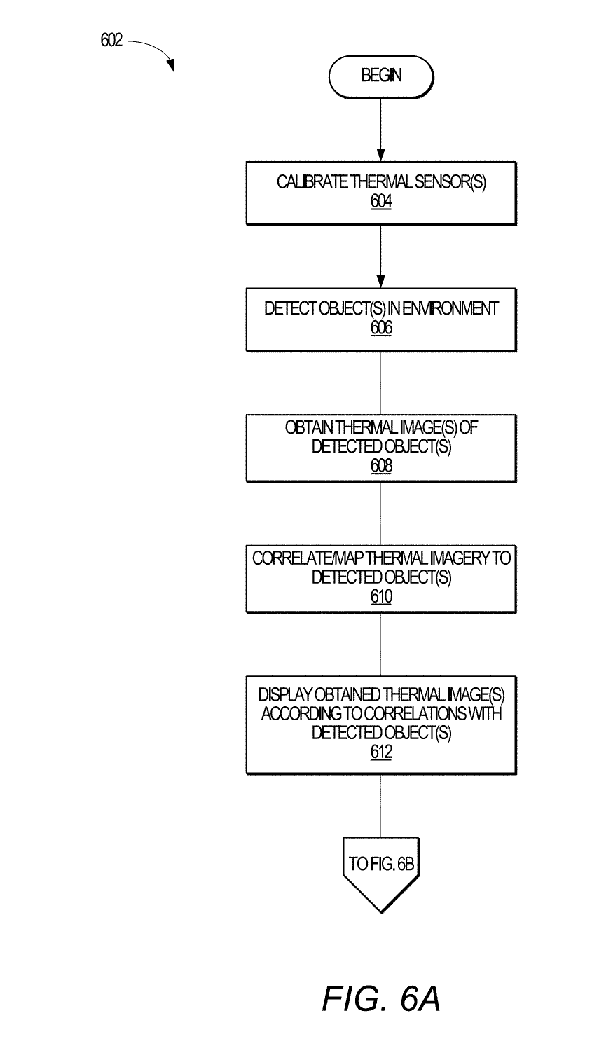

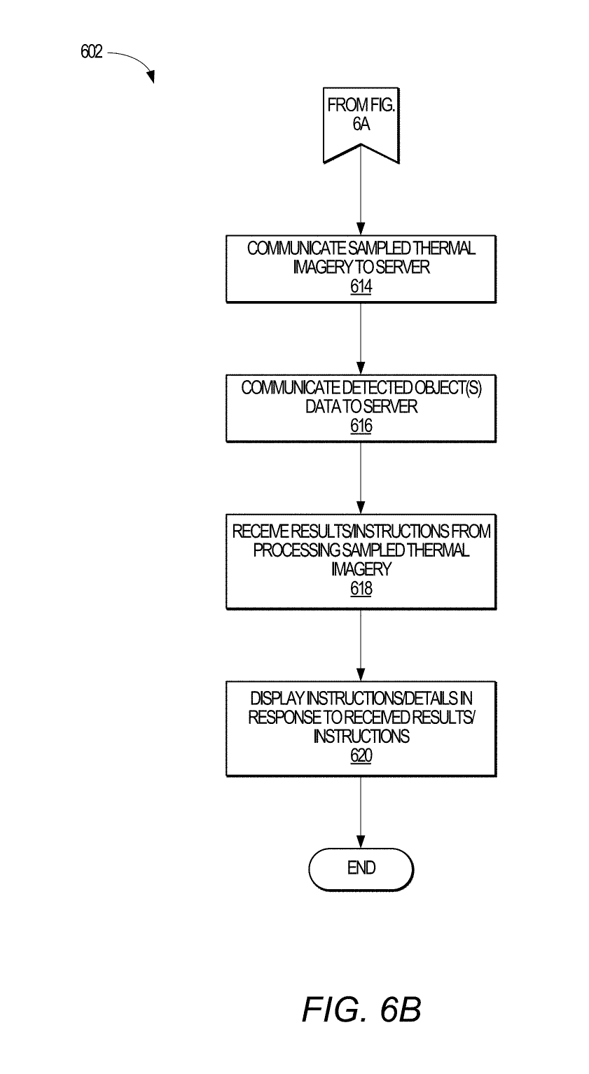

FIGS. 6A-6B illustrate a method 602, according to an example embodiment, implemented by the wearable computing device 104 of FIG. 1 for identifying objects and acquiring their corresponding thermal images. The method 602 may be implemented by one or more components of the wearable computing device 104 and is discussed by way of reference thereto.

Initially, the wearable computing device 104 may be thermally calibrated (Operation 604). Thermally calibrating the wearable computing device 104 may include exposing the one or more FLIR camera(s) 312 to ambient environment temperatures such that the FLIR camera(s) 312 can better identify objects from the surrounding environment. Alternatively, calibrating the wearable computing device 104 may include adjusting one or more thermal sensitivity thresholds of the FLIR camera(s) 312 to adjust the range (e.g., increase and/or decrease) of sensitivity the FLIR camera(s) 312 have to thermal energy. By calibrating the wearable computing device 104 prior to imaging an environment, the wearable computing device 104 can be configured to better detect objects that emit thermal energy.

The wearable computing device 104 then detects one or more objects (e.g., physical objects 106) within its environment (Operation 606). As explained above, the wearable computing device 104 may invoke or execute an object recognition module 218 that detects one or more objects within the environment of the wearable computing device 104. In one embodiment, the object recognition module 218 performs the object detection and/or identification. Additionally, and/or alternatively, the object recognition module 218 communicates with the server 112 via the communication interface 234 to detect and/or identify the one or more objects. For example, the object recognition module 218 may communicate one or more images to the server 112, which then performs the object identification and/or recognition. In this implementation, the server 112 then communicates the results of the object identification and/or recognition to the object recognition module 218. Information pertaining to the detected and/or identified one or more objects is then stored as the object recognition data 228.

The wearable computing device 104 next obtains thermal imagery from one or more of the detected objects (Operation 608). As explained with reference to FIGS. 2-3, the thermal imaging module 220 communicates with one or more FLIR camera(s) 312 to acquire thermal images of objects within the environment the wearable computing device 104. The acquired thermal images may then be stored as thermal imaging data 230. In addition, the thermal imaging module 220 may then associate the thermal imaging data 230 with one or more detected objects stored as the object recognition data 228 (Operation 610). For example, the thermal imaging module 220 may store one or more identifiers with the thermal imaging data 230, and use the identifiers as references for the object recognition data 228. In this manner, the thermal imaging module 220 can associate detected objects with their respective thermal images. In some instances, the thermal images may be stored as the thermal imaging data 230 without references in the object recognition data 228, such as where the object recognition module 218 is unable to identify and/or detect the object from which the thermal images were acquired.

The AR application 216 may then display the thermal imaging data 230 as augmented reality content and/or as part of the wearable computing device 104 operating in a user-selected thermal imaging mode (Operation 612). Where the thermal imaging data 230 is displayed as augmented reality content, the AR application 216 may correlate the thermal imaging data 230 with the object recognition data 228 such that, when the thermal imaging data 230 is displayed as the augmented reality content, the thermal imaging data 230 appears with its real-world counterpart. In one embodiment, correlating the thermal imaging data 230 with the object recognition data 228 may include one or more graphical transformations (e.g., translations, rotations, resizing, etc.) to align the coordinate system of the thermal imaging data 230 with the coordinate system of the object recognition data 228. Having aligned the thermal imaging data 230 with the object recognition data 228, the AR application 216 then displays the one or more thermal images on the display 204 via the communication bus 234. Alternatively, the thermal imaging data 230 may not be aligned with the object recognition data 228, such as where there is no correlating object for the thermal imaging data 230 in the object recognition data 228.

Using the thermal imaging data 230, the AR application 216 is further configured to inform the user 120 whether the displayed thermal images conform to expected thermal images (e.g., the thermal images are associated with one or more temperature values within an expected range of temperature values). Accordingly, and referring to FIG. 6B, the AR application 216 may communicate one or more of the thermal images to the server 112 via the communication interface 206 (Operation 614). In one embodiment, the AR application 216 communicates a sampled set of thermal images to the server 112 for analysis. In another embodiment, the AR application 216 continuously streams the thermal images to the server 112, such that the server 112 processes the received thermal images within a short period of time of the wearable computing device 104 having acquired them.

In addition, and to facilitate the processing of the communicated thermal images, the wearable computing device 104 may also communicate the detected object(s) associated with the thermal images communicated to the server 112 (Operation 616). By communicating the detected object(s) to the server 112 (e.g., the object recognition data 228), the wearable computing device 104 effectively informs the server 112 of the objects associated with the communicated thermal images. Alternatively, and/or additionally, the server 112 may perform one or more image recognition algorithms on the received thermal images to determine the type of objects associated with the thermal images.

Although the wearable computing device 104 may communicate the object recognition data 228 and/or the thermal imaging data 230 to the server 112 for further processing, the wearable computing device 104 may be configured to perform the analysis of the object recognition data 228 and/or the thermal imaging data 230. In this embodiment, the wearable computing device 104 may not communicate the object recognition data 228 and/or the thermal imaging data 230 to the server 112 but, instead, locally perform the processing of the data 228,230.

In one embodiment, the server 112 (or the wearable computing device 104) determines whether the thermal imaging data 230 indicates whether its corresponding object(s), or portions thereof, are operating within expected temperatures. As explained previously, the server 112 (or the wearable computing device 104) may store a baseline thermal imaging profile for one or more objects, where the baseline thermal imaging profile indicates the expected temperatures for an object operating under various conditions (e.g., one or more operating states). Using one or more image comparison techniques (e.g., machine learning, classification and/or categorizing, neural network training etc.), the server 112 and/or the wearable computing device 104 determines whether the received thermal imaging data 230 conforms to the baseline thermal imaging profile. Should the server 112 determine that there is a discrepancy in the thermal imaging data 230, the server 112 may then communicate instructions to and/or information to the wearable computing device 104 to be displayed to user 120 via the display 204 (Operation 618).

The wearable computing device 104 then, if applicable, acts upon the information received from the server 112, such as by displaying information about the objects associated with the thermal imaging data 230 (Operation 620). Such information and/or instructions may include whether the object(s) are emitting temperatures within a range associated with the operating condition of the object, whether there is a malfunction or damage to the object causing the temperatures associated with the thermal imaging data 230, how to repair or fix the object(s)

associated with the thermal imaging data 230, and other such information and/or instructions. In one embodiment, the information and/or instructions are displayed as augmented reality content within the field of view of the user 120 via the display 204.

Thus, this disclosure provides for a wearable computing device 104 configured to acquire thermal imagery for objects within an environment, including determining whether the acquired thermal imagery indicates whether one or more of the objects are experiencing a problem or are operating outside of expected parameters. In addition, the acquired thermal imagery may be displayed as augmented reality content such that the acquired thermal imagery appears overlaid on corresponding objects. As the wearable computing device 104 can use the acquired thermal energy to compare with previously obtained thermal imagery and/or a baseline thermal imaging profile, the wearable computing device 104 is configured to inform the user 120 whether an object associated with the acquired thermal energy is emitting thermal energy outside of expected parameters (e.g., via a comparison with the object's thermal imaging profile).

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Example Machine Architecture and Machine-Readable Medium

FIG. 7 is a block diagram illustrating components of a machine 700, according to some example embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example, the instructions may cause the machine to execute the method illustrated in FIGS. 6A-6B. Additionally, or alternatively, the instructions may implement one or more of the modules 212 illustrated in FIG. 2 and so forth. The instructions transform the general, non-programmed machine into a particular machine programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory 730, and I/O components 750, which may be configured to communicate with each other such as via a bus 702. In an example embodiment, the processors 710 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 712 and processor 714 that may execute instructions 716. The term “processor” is intended to include multi-core processor that may comprise two or more independent processors (sometimes referred to as “cores”) that may execute instructions contemporaneously. Although FIG. 7 shows multiple processors, the machine 700 may include a single processor with a single core, a single processor with multiple cores (e.g., a multi-core process), multiple processors with a single core, multiple processors with multiples cores, or any combination thereof.

The memory/storage 730 may include a memory 732, such as a main memory, or other memory storage, and a storage unit 736, both accessible to the processors 710 such as via the bus 702. The storage unit 736 and memory 732 store the instructions 716 embodying any one or more of the methodologies or functions described herein. The instructions 716 may also reside, completely or partially, within the memory 732, within the storage unit 736, within at least one of the processors 710 (e.g., within the processor's cache memory), or any suitable combination thereof, during execution thereof by the machine 700. Accordingly, the memory 732, the storage unit 736, and the memory of processors 710 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 716. The term “machine-readable medium” shall also be taken to include any medium, or combination of multiple media, that is capable of storing instructions (e.g., instructions 716) for execution by a machine (e.g., machine 700), such that the instructions, when executed by one or more processors of the machine 700 (e.g., processors 710), cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion and the grouping is in no way limiting. In various example embodiments, the I/O components 750 may include output components 752 and input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762 among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 762 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via coupling 782 and coupling 772 respectively. For example, the communication components 764 may include a network interface component or other suitable device to interface with the network 780. In further examples, communication components 764 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a Universal Serial Bus (USB)).

Moreover, the communication components 764 may detect identifiers or include components operable to detect identifiers. For example, the communication components 764 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 780 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network and the coupling 782 may be a Code Division Multiple Access (CDMA) connection, a Global System for Mobile communications (GSM) connection, or other type of cellular or wireless coupling. In this example, the coupling 782 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., hypertext transfer protocol (HTTP)). Similarly, the instructions 716 may be transmitted or received using a transmission medium via the coupling 772 (e.g., a peer-to-peer coupling) to devices 770. The term “transmission medium” shall be taken to include any intangible medium that is capable of storing, encoding, or carrying instructions 716 for execution by the machine 700, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A wearable computing device for providing augmented reality images of an environment in which the wearable computing device is worn, the wearable computing device comprising:
a machine-readable memory storing computer-executable instructions; and
at least one hardware processor in communication with the machine-readable memory that, when the computer-executable instructions are executed, configures the wearable computing device to perform a plurality of operations, the plurality of operations comprising:
detecting one or more objects in an environment in which the wearable computing device is being worn, each of the one or more objects being associated with a corresponding first set of coordinates indicating a location of each of the one or more objects;
acquiring, by one or more cameras of the wearable computing device, one or more thermal images of at least one object of the detected one or more objects, the acquired one or more thermal images being associated with a second set of coordinates indicating a location of each of the acquired one or more thermal images;
determining a third set of coordinates for displaying the acquired one or more thermal images as a texture based on aligning the second set of coordinates with the first set of coordinates;
obtaining one or more instructions relating to the at least one object of the detected one or more objects based on the one or more acquired thermal images;
displaying the one or more acquired thermal images based on the third set of coordinates;
generating augmented reality content having the obtained one or more instructions; and
displaying, by a display of the wearable computing device, the generated augmented reality content with the one or more of the acquired thermal images of the at least one object of the detected one or more objects.

2. The wearable computing device of claim 1, wherein the plurality of operations further comprises:
comparing one or more of the acquired one or more thermal images with one or more previously obtained thermal images of the at least one object of the detected one or more objects; and
obtaining the one or more instructions comprises generating instructions based on the comparison.

3. The wearable computing device of claim 2, wherein:
the one or more previously obtained thermal images relate to an operating state of the at least one object of the detected one or more objects; and
the instructions comprise a notification that the at least one object of the detected one or more objects is operating outside expected operating parameters.

4. The wearable computing device of claim 1, wherein obtaining the one or more instructions comprises:
communicating the acquired one or more thermal images to a server in communication with the wearable computing device; and
receiving the one or more instructions in response to the communication of the acquired one or more thermal images.

5. The wearable computing device of claim 1, wherein the plurality of operations further comprises:
obtaining a three-dimensional model of the at least one object of the one or more detected objects; and
displaying the acquired one or more thermal images as a texture applied to one or more surfaces of the three-dimensional model.

6. (canceled)

7. The wearable computing device of claim 1, wherein the plurality of operations further comprises:
identifying the at least one object of the detected one or more objects; and
wherein the one or more instructions are obtained in response to a comparison of the acquired one or more thermal images with a baseline thermal imaging profile associated with the identified at least one object.

8. A computer-implemented method for providing augmented reality images of an environment in which the wearable computing device is worn, the method comprising:
detecting, by a wearable computing device, one or more objects in an environment in which the wearable computing device is being worn, each of the one or more objects being associated with a corresponding first set of coordinates indicating a location of each of the one or more objects;
acquiring, by one or more cameras of the wearable computing device, one or more thermal images of at least one object of the detected one or more objects, the acquired one or more thermal images being associated with a second set of coordinates indicating a location of each of the acquired one or more thermal images;
determining a third set of coordinates for displaying the acquired one or more thermal images as a texture based on aligning the second set of coordinates with the first set of coordinates;
obtaining one or more instructions relating to the at least one object of the detected one or more objects based on the one or more acquired thermal images;
displaying the one or more acquired thermal images based on the third set of coordinates;
generating augmented reality content having the obtained one or more instructions; and
displaying, by a display of the wearable computing device, the generated augmented reality content with one or more of the acquired thermal images of the at least one object of the detected one or more objects.

9. The computer-implemented method of claim 8, further comprising:
comparing one or more of the acquired one or more thermal images with one or more previously obtained thermal images of the at least one object of the detected one or more objects; and
obtaining the one or more instructions comprises generating instructions based on the comparison.

10. The computer-implemented method of claim 9, wherein:
the one or more previously obtained thermal images relate to an operating state of the at least one object of the detected one or more objects; and
the instructions comprise a notification that the at least one object of the detected one or more objects is operating outside expected operating parameters.

11. The computer-implemented method of claim 8, wherein obtaining the one or more instructions comprises:
communicating the acquired one or more thermal images to a server in communication with the wearable computing device; and
receiving the one or more instructions in response to the communication of the acquired one or more thermal images.

12. The computer-implemented method of claim 8, further comprising:
obtaining a three-dimensional model of the at least one object of the one or more detected objects; and
displaying the acquired one or more thermal images as a texture applied to one or more surfaces of the three-dimensional model.

13. (canceled)

14. The computer-implemented method of claim 8, further comprising:
identifying the at least one object of the detected one or more objects; and
wherein the one or more instructions are obtained in response to a comparison of the acquired one or more thermal images with a baseline thermal imaging profile associated with the identified at least one object.

15. A machine-readable medium having computer-executable instructions stored thereon that, when executed by at least one hardware processor, cause a wearable computing device to perform a plurality of operations comprising:
detecting one or more objects in an environment in which the wearable computing device is being worn, each of the one or more objects being associated with a corresponding first set of coordinates indicating a location of each of the one or more objects;
acquiring, by one or more cameras of the wearable computing device, one or more thermal images of at least one object of the detected one or more objects, the acquired one or more thermal images being associated with a second set of coordinates indicating a location of each of the acquired one or more thermal images;
determining a third set of coordinates for displaying the acquired one or more thermal images as a texture based on aligning the second set of coordinates with the first set of coordinates;
obtaining one or more instructions relating to the at least one object of the detected one or more objects based on the one or more acquired thermal images;
displaying the one or more acquired thermal images based on the third set of coordinates;
generating augmented reality content having the obtained one or more instructions; and
displaying, by a display of the wearable computing device, the generated augmented reality content with one or more of the acquired thermal images of the at least one object of the detected one or more objects.

16. The machine-readable medium of claim 15, wherein the plurality of operations further comprises:
comparing one or more of the acquired one or more thermal images with one or more previously obtained thermal images of the at least one object of the detected one or more objects; and
obtaining the one or more instructions comprises generating instructions based on the comparison.

17. The machine-readable medium of claim 14, wherein:
the one or more previously obtained thermal images relate to an operating state of the at least one object of the detected one or more objects; and
the instructions comprise a notification that the at least one object of the detected one or more objects is operating outside expected operating parameters.

18. The machine-readable medium of claim 15, wherein obtaining the one or more instructions comprises:
communicating the acquired one or more thermal images to a server in communication with the wearable computing device; and
receiving the one or more instructions in response to the communication of the acquired one or more thermal images.

19. The machine-readable medium of claim 15, wherein the plurality of operations further comprises:
obtaining a three-dimensional model of the at least one object of the one or more detected objects; and
displaying the acquired one or more thermal images as a texture applied to one or more surfaces of the three-dimensional model.

20. (canceled)
